(19) United States
(12) Patent Application Publication
(10) Pub. No.: US 2011/0148600 A1
(43) Pub. Date: Jun. 23, 2011

(54) APPARATUS AND METHODS FOR SELF-POWERED WIRE FREE DATA NETWORKS

(76) Inventor: Roger Bishop, Dayton, NV (US)

(21) Appl. No.: 12/640,022

(22) Filed: Dec. 17, 2009

(51) Int. Cl. H04Q 5/22

(52) U.S. Cl. 340/10.34

(57) ABSTRACT

A self-powered wire free data network method (D) that includes at least one self-powered wire free transmission apparatus (A), self-powered wire free receiver apparatus (B) or self-powered wire free transceiver apparatus (C) makes capable the wire free transmission and reception of environmental conditions whereby the processing of said data makes capable the control of various processes. A self-powered wire data network (E) that includes at least one self-powered wire free transmission apparatus (A), self-powered wire free receiver apparatus (B) and at least one self-powered wire free transceiver apparatus (C) makes capable the wire free transmission and reception of environmental conditions over extended distances whereby the processing of said data makes capable the control of various processes.

### CROSS REFERENCE TO RELATED APPLICATION

Not applicable.

### BACKGROUND OF THE INVENTION

1. Field of the Invention

The present invention relates generally to self powered radio systems and related methods for acquisition of electronic data and the wireless transmission thereof.

2. Description of the Prior Art

Data acquisition and the wireless transmission thereof are well known in prior art. Two examples of wireless sensor systems are disclosed in U.S. Pat. No. 7,230,532 B2 and 6,259,372 B1.

U.S. Pat. No. 7,230,532 B2 discloses a wireless sensor system whereby a voltage generator converts non-electrical energy to electrical energy that is stored. The said stored energy is voltage converted and used to operate a processor controller that contains the measured the value of a proximate sensor. A transmitter enables wire-free transmission of messages that can be produced by the processor controller. A timer is provided which can be triggered as a function of the voltage level of the energy store to activate the sensor system in order to transmit at least one message after a specific time interval.

U.S. Pat. No. 6,259,372 B1 discloses a method for a self-powered wireless transducer for monitoring external physical conditions whereby an energy conversion source such as a piezoelectric sensor is used to sense external physical conditions and create electrical power to power a RF transmitting circuit that transmits signals indicative of the external physical conditions. The self-powered wireless transducer includes a voltage storage device to receive electrical voltage from the piezoelectric sensor and a voltage detector to detect the voltage level on the voltage storage device. Once the voltage detector detects a predetermined voltage level, an oscillating transmitter is activated for a brief hysteresis period of the voltage detector. The information transmitted includes fault detection and the address of the transmission origin.

Although prior art is useful for certain applications and under particular conditions, the prior art demonstrates weaknesses in capability to maintain operation beyond the energy capacity of the storage device proximate to the wireless sensor system. Another problem with prior art is the free space ranges over which the wireless transmission of data and information can be effectively achieved is limited to the radio transmitter's effective isotropic radiated power which is consequent to the limited energy capacity of the storage device proximate to the radio system and consequent to the antenna gain proximate to the transmitter. Moreover the free space range is also limited consequent to the sensitivity of the wireless receiving device.

Another problem with prior art wireless system does not facilitate the networking of two or more systems such that data and information may be shared among a constellation of wireless systems or be simply repeated between systems to extend the effective free space transmission range.

Therefore; it is the object of the present invention to provide apparatus and methods apparatus for self-powered wire free data networks that make capable the acquisition, processing, wire free transmission and reception of data that includes but is not limited to environmental conditions, industrial process control or scientific instrumentation.

It is a further objective of the present invention to provide apparatus and methods that make capable energy generation and storage that makes capable the operation of the self-powered wire free data system beyond the natural energy capacity of the storage device. It is a further objective of the present invention to provide apparatus and methods for self-powered, wire free data transmission and reception that makes capable the extension of the effective wire free range of the wire free data network.
It is yet another object of the present invention to provide apparatus and methods that make capable the networking of similar wire free data networks and/or other data systems that includes but is not limited to data terminal equipment and computers that make capable the extended functionality of the wire free network of the present invention.

### SUMMARY OF THE INVENTION

In view of the foregoing disadvantages inherent in the known types of wire free sensor systems present in the prior art, the present invention provides new apparatus and methods for a self-powered wire free data networks that make capable the acquisition, processing, wire free transmission and reception of information and/or data that makes capable solutions to the aforementioned problems and make capable an effective and efficient means of data acquisition from proximate environmental sensors and/or the manipulation of industrial process control points as two examples.

In accordance with one embodiment of the present invention, a self-powered wire free transmission apparatus possessing an energy generation device, an energy storage device, at least one wire free transmitter device, at least one processor control device, at least one analog to digital conversion device, at least one digital input/output device, at least one serial data communications device and possessing a digitally encoded device identity is capable to acquiring and processing data concerning environmental conditions, provide control point data to independent control devices and transmit data by wire free method. The self-powered wire free transmission apparatus capable to transmit and receive data from a coupled data terminal such as a computer. A self-powered wire free receiver apparatus possessing an energy generation device, an energy storage device, at least one wire free receiver device, at least one processor control device, at least one analog to digital conversion device, at least one digital input/output device, at least one serial data communication device and possessing a digitally encoded device identity is capable to receive data from the aforementioned self-powered wire free transmission device in a wire free method. The self-powered wire free receiver apparatus capable to acquiring and processing data concerning environmental conditions and provide control point data to independent control devices. The receiver apparatus is programmable to execute a predetermined response to the data received from each of the plurality of self-powered wire free transmission and/or transceiver apparatus when desired and capable to transmit and receive data from coupled data terminal equipment and computers as two examples.

In accordance with another embodiment of the present invention, a plurality of the aforementioned self-powered wire free transmission apparatus and self-powered wire free receiver apparatus whereby a wire free data network is created. Wherein each self-powered wire free transmission apparatus possesses unique digitally encoded device identity which is transmitted inclusively with acquired data to provide the identity of the transmission device responsible for transmitted data. Wherein each self-powered wire free receiver apparatus capable to receiving data transmissions from a plurality of self-powered wire free transmission apparatus is programmable to execute a predetermined response to the data received from each of the plurality of self-powered wire free transmission apparatus when desired.

In accordance with yet another embodiment of the present invention, a self-powered wire free transceiver apparatus possessing an energy generation device, an energy storage device, at least one wire free transmitter device, at least one wire free receiver device, at least one processor control device, at least one analog to digital conversion device, at least one digital input/output device, at least one serial data communication port and possessing digitally encoded device identity is capable to acquiring and processing data concerning environmental conditions, provide control point data to independent control devices, transmit and receive data by wire free method. Wherein each self-powered wire free transceiver apparatus capable to receiving data transmissions from a plurality of self-powered wire free transmission and/or transceiver apparatus and capable to transmit data to a plurality of receiver and/or transceiver apparatus, the transceiver constitutes a wire free repeater capable to extend the effective wire free range and size of the wire free data network. The transceiver apparatus is programmable to execute a predetermined response to the data received from each of the plurality of self-powered wire free transmission and/or transceiver apparatus when desired and capable to transmit and receive data from coupled data terminal equipment and computers as two examples.

In accordance with yet another embodiment of the present invention, a plurality of the aforementioned self-powered wire free transmission apparatus, self-powered wire free receiver apparatus and self-powered wire free transceiver apparatus whereby a wire free data network is created possessing extended wire free range, possessing virtually unlimited capacity to accommodate additional transmission, receiver and/or transceiver apparatus and wherein each self-powered wire free transmission and/or transceiver apparatus possesses unique digitally encoded device identity that is transmitted inclusively with acquired data to provide the identity of the transmission and/or transceiver apparatus responsible for transmitted data and wherein each self-powered wire free receiver and transceiver apparatus capable to receiving data transmissions from a plurality of self-powered wire free transmission and transceiver apparatus is programmable to execute a predetermined response to the data received from each of the plurality of self-powered wire free transmission and/or transceiver apparatus when desired and whereby self-powered wire free transceiver apparatus capable to wire free retransmission of received data transmissions from a plurality of self-powered wire free transmission and/or transceiver apparatus increases the effective transmission range of the wire free data network.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of a preferred embodiment of a self-powered wire free transmission apparatus.

FIG. 2 is a block diagram of a preferred embodiment of a self-powered wire free receiver apparatus.

FIG. 3 is a block diagram of a preferred embodiment of a self-powered wire free transceiver apparatus.

FIG. 4 is a block diagram of a first embodiment of a wire free data network method.

FIG. 5 is a block diagram of a second embodiment of a wire free data network method possessing extended wire free range.

### DESCRIPTION OF THE PREFERRED EMBODIMENTS

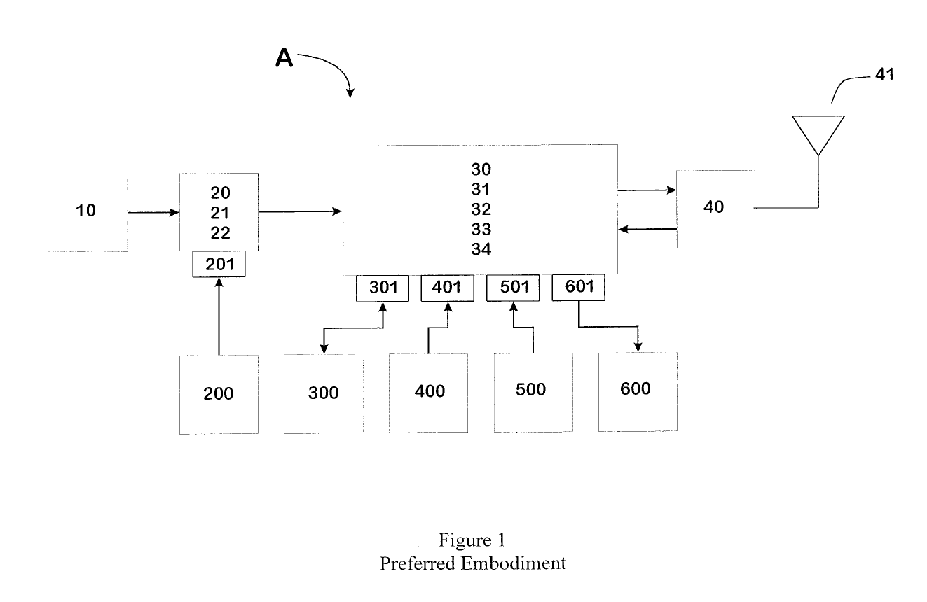

Turning now descriptively to the drawings, in which similar reference characters denote similar elements throughout the several views, FIG. 1 generally illustrates a self-powered wire free transmission apparatus (A) includes an energy generation device (10) that converts non-electrical energy into electrical energy. In the preferred embodiment of the present invention the energy generation device (10) is a photovoltaic cell. However other energy generation devices (10) are also suitable including but not limited to; piezoelectric devices, thermoelectric devices, electrochemical devices and other materials or devices that are generally capable of generating electrical energy from the surrounding environment. Those knowledgeable in the art understand what energy generation devices (10) are best suited for a particular environment. Electric current generated by the energy generation device (10) is electrically coupled to the energy storage device (20) to charge and/or maintain a charge within the energy storage device (20). In the preferred embodiment of the present invention the energy storage device (20) consists of a chemical based rechargeable battery. However other energy storage devices (20) are also suitable including but not limited to capacitive devices. To prevent damage to either the energy generation device (10) or the energy storage device (20) due to excessive voltage or current, a polarity sensing current limiting device (21) is incorporated into the energy storage device (20). Electrical energy from the energy storage device (20) is electrically coupled to and powers the entire wire free transmission apparatus (A). The wire free transmitter apparatus (A) possessing at least one direct current input port (201) electrically coupled to at least one voltage regulation device (22) makes capable to electrically couple to at least one external direct current power source (200) to provide alternative power to the wire free transmission apparatus (A).

The wire free transmission apparatus (A) possessing at least one processor controller (30) regulates the data acquisition, processing, wire free data transmission and data transfer tasks according to a programmable predetermined algorithm, the state of charge of the energy storage device (20) and a first periodic or pseudo-random timing algorithm generated by the processor controller (30). In the preferred embodiment of the present invention the processor controller (30) is a microcontroller possessing integrated circuitry and functionality that includes but is not limited to analog to digital converter device (31), digital input and output devices (32) (33), serial data communication device (34) and a radio frequency transmitter device (40). However, other processor controllers (30) are also suitable. During the time the processor controller (30) is not performing data acquisition, processing, data transmission and/or data transfer tasks, the entire wire free transmission apparatus (A) is placed into a low power consumption inactive state to conserve electrical power. A second periodic or pseudo-random timing algorithm generated by the processor controller (30) brings the wire free transmission apparatus (A) out of the inactive state and into an active state at periodic or pseudo-random intervals to perform subsequent data acquisition, processing, data transmission and data transfer tasks.

The wire free transmission apparatus (A) possessing at least one port (301) electrically coupled to at least one serial communication device (34), at least one port (401) electrically coupled to at least one analog to digital conversion device (31), at least one port (501) electrically coupled to at least one digital input device (32) and at least one port (601) electrically coupled to at least one digital output device (33) makes capable the electrical coupling of data terminal devices (300), various analog sensing devices (400), various digital sensing devices (500) and digital control devices (600) to the wire free transmission apparatus (A). Those knowledgeable in the art understand what data terminal, sensing and control devices are best suited for a particular application and environment. The at least one serial communication device (34), at least one analog to digital conversion device (31), at least one digital input device (32) and at least one digital output device (33) are electrically coupled to the processor controller (30) which acquires the digital data presented by the at least one analog to digital conversion device (31) and the at least one digital input device (32) at periodic or pseudo-random time intervals at which time the wire free transmission apparatus (A) is in an active state. During the time the wire free transmission apparatus (A) is in an active state, the digital data acquired is processed by the processor controller (30) to determine if a change of state is required for the at least one digital output device (33) according to predetermined processor controller (30) algorithms. During the time the wire free transmission apparatus (A) is in an active state, the processed data is structured for transmission by the wire free radio frequency transmitter (40) and/or the serial communication device (34). The data structure may include but is not limited to identification information relating to the coupled sensors (400) (500), identification information relating to the wire free transmission apparatus (A), information relating to the status of digital outputs (33), address data for at least one wire free receiver apparatus (B) or wire free transceiver apparatus (C), operational instructions for at least on wire free receiver apparatus (B) or wire free transceiver apparatus (C) and information concerning data error correction. The wire free transmission apparatus (A) possessing at least one electrically coupled port (301) to at least one serial data communications (34) device makes capable the transfer of information between the processor controller (30) of the wire free transmission apparatus (A) and a coupled data terminal equipment (300).

The wire free transmission apparatus (A) possessing at least one radio frequency transmitter device (40) that is electrically coupled to a radio frequency antenna (41) makes capable the efficient wire free transmission of at least one modulated radio carrier frequency. In the preferred embodiment of the present invention the wire free transmission device (30) is an integrated device possessing all the circuitry and functionality required to generate, modulate and amplify a modulated radio carrier frequency. However other radio frequency transmitter circuits and device (40) are also suitable. Those knowledgeable in the art understand what transmitter circuits and devices are best suited for wire free transmitters. The wire free transmitter device (40) being electrically coupled to the processor controller (30) receives processed digital data from the processor controller (30). The data received by the wire free transmission device (40) from the processor controller (30) is processed by the wire free transmission device (40) to modulated at least one radio carrier frequency. In the preferred embodiment of the present invention the frequencies assigned to the international ISM bands are preferred carrier frequencies. However other frequencies are also suitable and may include frequencies outside the assigned international ISM bands. In the preferred embodiment of the present invention amplitude shift keying modulation of the radio frequency carrier is employed. However other modulation schemes are suitable that includes but is not limited to frequency shift keying, phase shift keying, frequency modulation and quadrature amplitude modulation. During the time the wire free transmission apparatus (A) is in an active state, the processor controller (30) commands the wire free transmission device (40) to transmit the processed data. To mitigate data errors, the processor controller (30) may command the wire free transmission device (40) to transmit the processed data more than once and in periodic or pseudo-random time intervals during the time the wire free transmission apparatus (A) is in an active state.

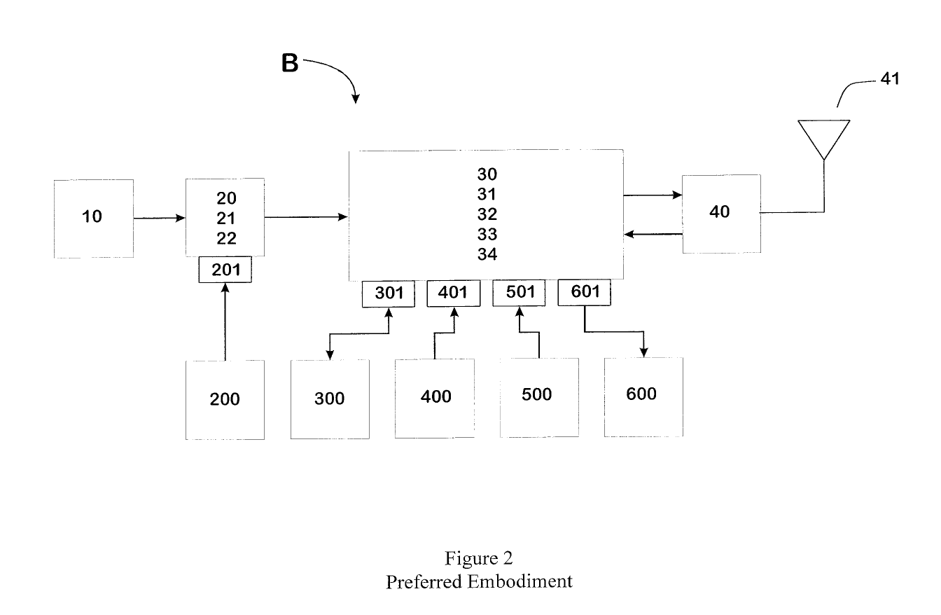

FIG. 2 generally illustrates a self-powered wire free receiver apparatus (B) includes an energy generation device (10) that converts non-electrical energy into electrical energy. In the preferred embodiment of the present invention the energy generation device (10) is a photovoltaic cell. However other energy generation devices (10) are also suitable including but not limited to; piezoelectric devices, thermoelectric devices, electrochemical devices and other materials or devices that are generally capable of generating electrical energy from the surrounding environment. Those knowledgeable in the art understand what energy generation devices (10) are best suited for a particular environment. Electric current generated by the energy generation device (10) is electrically coupled to the energy storage device (20) to charge and/or maintain a charge within the energy storage device (20). In the preferred embodiment of the present invention the energy storage device (20) consists of a chemical based rechargeable battery. However other energy storage devices (20) are also suitable including but not limited to capacitive devices. To prevent damage to either the energy generation device (20) or the energy storage device due to excessive voltage or current, a polarity sensing current limiting device (21) is incorporated into the energy storage device (20). Electrical energy from the energy storage device (20) is electrically coupled to and powers the entire wire free receiver apparatus (B). The wire free receiver apparatus (B) possessing at least one direct current input port (201) electrically coupled to at least one voltage regulation device (22) makes capable to electrically couple to at least one external direct current power source (200) to provide alternative power to the wire free receiver apparatus (B).

The wire free receiver apparatus (B) possessing at least one processor controller (30) regulates wire free data reception, data acquisition, processing and data transfer tasks according to a programmable predetermined algorithm, the state of charge of the energy storage device (20) and a first periodic or pseudo-random timing algorithm generated by the processor controller (30). In the preferred embodiment of the present invention the processor controller (30) is a microcontroller possessing integrated functionality that includes but is not limited to analog to digital converters (31), digital input and output (32) (33) and serial data communication (34). However, other processor controllers (30) are also suitable. During the time that the processor controller (30) is not performing wire free data reception, data acquisition, processing and/or data transfer tasks, the entire wire free receiver apparatus (B) is placed into a low power consumption inactive state to conserve electrical power until a second periodic or pseudo-random timing algorithm generated by the processor controller (30) brings the wire free receiver apparatus (B) out of the inactive state and into an active state at periodic or pseudo-random intervals to perform subsequent wire free data reception, data acquisition, processing and/or data transfer tasks.

The wire free transmission apparatus (B) possessing at least one port (300) electrically coupled to at least one serial communication device (34), at least one port electrically coupled to at least one analog to digital conversion device (31), at least one port electrically coupled to at least one digital input device (32) and at least one port electrically coupled to at least one digital output device (33) makes capable the electrical coupling of various analog devices (400) and/or various digital sensing devices (500) and digital control devices (600). Those knowledgeable in the art understand what sensing and control devices are best suited for a particular application and environment. The at least one serial communication device (34), at least one analog to digital conversion device (31), at least one digital input device (32) and at least one digital output device are electrically coupled to the processor controller (30) which acquires the digital data presented by the at least one analog to digital conversion device (31) and the at least one digital input device (32) at periodic or pseudo-random time intervals during the time the wire free receiver apparatus (B) is in an active state. During the time the wire free receiver apparatus (B) is in an active state, the digital data acquired is processed by the processor controller (30) to determine if a change of state is required for the at least one digital output device (33) according to predetermined processor controller (30) algorithms. During the time the wire free receiver apparatus (B) is in an active state, the wire free receiver apparatus (B) is capable to receive structured data transmitted from at least one wire free transmission apparatus (A) and/or wire free transceiver apparatus (C). The structure data received by the wire free receiver apparatus (B) embodies information concerning and acquired by the wire free transmission apparatus (A) or the wire free transceiver apparatus (C) that may include but is not limited to identification information relating to the wire free transmission apparatus (A) or wire free transceiver apparatus (C), identification information relating to the coupled sensors (400) (500), information relating to the status of digital outputs (33), address data for at least one wire free receiver apparatus (B) or wire free transceiver apparatus (C), operational instructions for at least on wire free receiver apparatus (B) or wire free transceiver apparatus (C) and information concerning data error correction. The wire free receiver apparatus (B) possessing at least one port electrically coupled to at least one serial data communications (34) device makes capable the transfer of information between the wire free receiver apparatus (B) and a coupled data terminal equipment (300).

The wire free receiver apparatus (B) possessing at least one radio frequency receiver device (50) that is electrically coupled to a radio frequency antenna (51) to facilitate the efficient wire free reception of at least one modulated radio carrier frequency. In the preferred embodiment of the present invention frequencies assigned to the international ISM bands are preferred carrier frequencies. However other frequencies are also suitable and may include frequencies outside the assigned international ISM bands. In the preferred embodiment of the present invention the wire free receiver device (50) is an integrated circuit possessing all the circuitry and functionality required to amplify, heterodyne, demodulate and convert to a digital data a received modulated radio carrier frequency and convert this signal into digital data. However other radio frequency receiver circuits and devices (50) are also suitable. Those knowledgeable in the art understand what receiver circuits and devices (50) are best suited for wire free receivers. Moreover in the preferred embodiment of the present invention demodulation of an at least one amplitude shift keyed wire free carrier frequency is employed. However other demodulation schemes are suitable for other wire free carrier modulation schemes that include but are not limited to frequency shift keying, phase shift keying, frequency modulation and quadrature amplitude modulation. The processor controller (30) being electrically coupled to the wire free receiver device (50) receives the digital data from the wire free receiver device (50). The digital data received by the processor controller (30) is processed by the processor controller (30) according to predetermined algorithms to determine the response by the processor controller (30) that may include but is not limited to the changing of the state of the at least one digital output device (33). During the time interval that the processor controller (30) is in an active state, the processor controller (30) commands the wire free receiver device (50) to receive and demodulated transmitted data. To mitigate data errors, the processor controller (30) may command the wire free receiver device (50) to receive and demodulate transmitted data more than once and in periodic or pseudo-random time intervals during time that the wire free receiver apparatus (B) is in an active state.

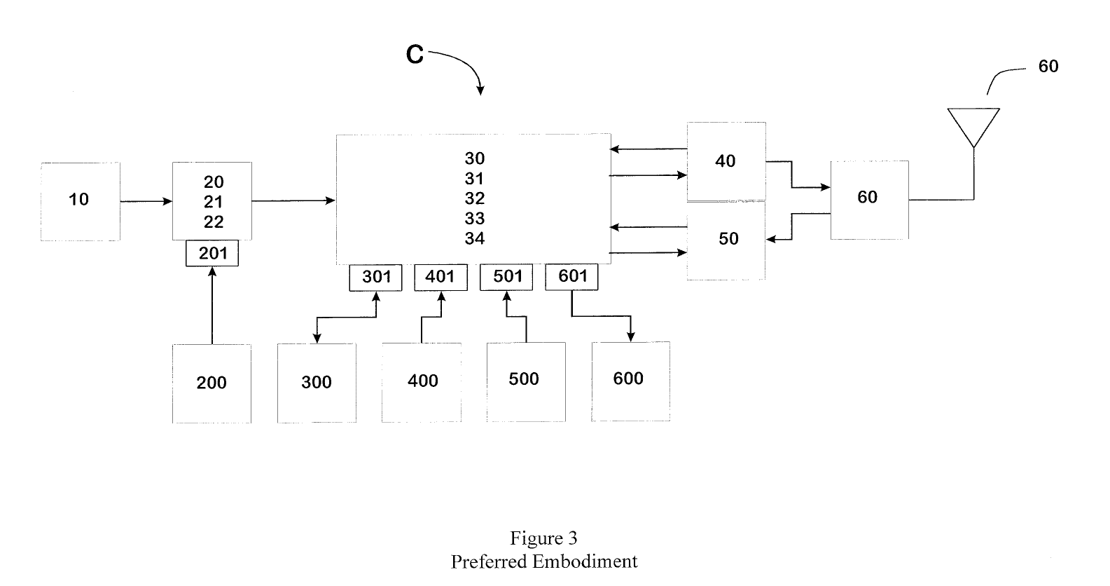

FIG. 3 generally illustrates a self-powered wire free transceiver apparatus (C) includes an energy generation device (10) that converts non-electrical energy into electrical energy. In the preferred embodiment of the present invention the energy generation device (10) is a photovoltaic cell. However other energy generation devices (10) are also suitable including but not limited to; piezoelectric devices, thermoelectric devices, electrochemical devices and other materials or devices that are generally capable of generating electrical energy from the surrounding environment. Those knowledgeable in the art understand what energy generation devices (10) are best suited for a particular environment. Electric current generated by the energy generation device (10) is electrically coupled to the energy storage device (20) to charge and/or maintain a charge within the energy storage device (20). In the preferred embodiment of the present invention the energy storage device (20) consists of a chemical based rechargeable battery. However other energy storage devices (20) are also suitable including but not limited to capacitive devices. To prevent damage to either the energy generation device (20) or the energy storage device due to excessive voltage or current, a polarity sensing current limiting device (21) is incorporated into the energy storage device (20). Electrical energy from the energy storage device (20) is electrically coupled to and powers the entire wire free transceiver apparatus (C). The wire free transceiver apparatus (C) possessing at least one direct current input port (201) electrically coupled to at least one voltage regulation device (22) makes capable to electrically couple to at least one external direct current power source (200) to provide alternative power to the wire free transceiver apparatus (C).

The wire free transceiver apparatus (C) possessing at least one processor controller (30) regulates the data acquisition, processing, wire free data reception, wire free data transmission and data transfer tasks according to a programmable predetermined algorithm, the state of charge of the energy storage device (20) and a first periodic or pseudo-random timing algorithm generated by the processor controller (30). In the preferred embodiment of the present invention the processor controller (30) is a microcontroller possessing integrated circuitry and functionality that includes but is not limited to analog to digital converter device (31), digital input devices (32), digital output devices (33), serial data communication device (34) and a radio frequency transmitter device (40). However, other processor controllers (30) are also suitable. During the time the processor controller (30) is not performing data acquisition, processing, wire free data reception, wire free data transmission and/or data transfer tasks, the entire wire free transceiver apparatus (C) is placed into a low power consumption inactive state to conserve electrical power. A second periodic or pseudo-random timing algorithm generated by the processor controller (30) brings the wire free transceiver apparatus (C) out of the inactive state and into an active state at periodic or pseudo-random intervals to perform subsequent data acquisition, processing, wire free data reception, wire free data transmission and data transfer tasks.

The wire free transceiver apparatus (C) possessing at least one port (301) electrically coupled to at least one serial communication device (34), at least one port (401) electrically coupled to at least one analog to digital conversion device (31), at least one port (501) electrically coupled to at least one digital input device (32) and at least one port (601) electrically coupled to at least one digital output device (33) makes capable the electrical coupling of various analog devices (400) and/or various digital sensing devices (500) and various digital control devices (600). Those knowledgeable in the art understand what sensing and control devices (400), (500), (600) are best suited for a particular application and environment. The at least one serial communication device (34), at least one analog to digital conversion device (31), at least one digital input device (32) and at least one digital output device (33) are electrically coupled to the processor controller (30) which acquires the digital data presented by the at least one analog to digital conversion device (31) and the at least one digital input device (32) at periodic or pseudo-random time intervals during the time the wire free transceiver apparatus (C) is in an active state. During the time the wire free transceiver apparatus (C) is in an active state, the digital data acquired is processed by the processor controller (30) to determine if a change of state is required for the at least one digital output device (33) according to predetermined processor controller (30) algorithms. During the time the wire free transceiver apparatus (C) is in an active state, the processed data is structured for transmission by the wire free radio frequency transmitter (40) and/or the serial communication device (34). The data structure may include but is not limited to identification information relating to the coupled sensors (400), (500), identification information relating to the wire free transmission apparatus (A), information relating to the status of digital output devices (33), address data for at least one wire free receiver apparatus (B) or wire free transceiver (C), operational instructions for at least on wire free receiver apparatus (B) or wire free transceiver (C) and information concerning data error correction. During the time the wire free transceiver apparatus (C) is in an active state, the wire free transceiver apparatus (C) is capable to receive structured data transmitted from at least one wire free transmission apparatus (A) and/or wire free transceiver apparatus (C) and makes capable to retransmit the structured data for reception by at least one wire free reception apparatus (B) and/or wire free transceiver apparatus (C) and/or the wire free transceiver apparatus (C) is capable to respond to the received structured data. The structure data received by the wire free transceiver apparatus (C) embodies information concerning and acquired by the wire free transmission apparatus (A) or the wire free transceiver apparatus (C) that may include but is not limited to identification information relating to the wire free transmission apparatus (A) or wire free transceiver apparatus (C), identification information relating to the coupled sensors (400), (500), information relating to the status of digital output devices (33), address data for at least one wire free receiver apparatus (B) or wire free transceiver apparatus (C), operational instructions for at least on wire free receiver apparatus (B) or wire free transceiver apparatus (C) and information concerning data error correction. The wire free transceiver apparatus (C) possessing at least one port electrically coupled to at least one serial data communications (34) device makes capable the transfer of information between the wire free transceiver apparatus (C) and a coupled data terminal equipment (300).

The wire free transceiver apparatus (C) possessing at least one radio frequency transmitter device (40) that is electrically coupled to a switch (60) that is electrically coupled to a radio frequency antenna (61) to make capable the efficient wire free transmission of at least one modulated radio carrier frequency. In the preferred embodiment of the present invention the wire free transmitter device (40) is an integrated device possessing all the circuitry and functionality required to generate, modulate and amplify a modulated radio carrier frequency. However other radio frequency transmitter circuits and device (40) are also suitable. Those knowledgeable in the art understand what transmitter circuits and devices (40) are best suited for wire free transmitters. The wire free transmitter device (40) being electrically coupled to the processor controller (30) receives processed digital data from the processor controller (30). The data received by the wire free transmission device (40) from the processor controller (30) is processed by the wire free transmission device (40) to modulated at least one radio carrier frequency. In the preferred embodiment of the present invention the frequencies assigned to the international ISM bands are preferred carrier frequencies. However other frequencies are also suitable and may include frequencies outside the assigned international ISM bands. In the preferred embodiment of the present invention amplitude shift keying modulation of the radio frequency carrier is employed. However other modulation schemes are suitable that includes but is not limited to frequency shift keying, phase shift keying, frequency modulation and quadrature amplitude modulation. During the time the wire free transceiver apparatus (C) is in an active state, the processor controller (30) commands the wire free transmission device (40) to transmit the processed data. To mitigate data errors, the processor controller (30) may command the wire free transmission device (40) to transmit the processed data more than once and in periodic or pseudo-random time intervals during the time the wire free transceiver apparatus (C) is in an active state.

The wire free transceiver apparatus (C) possessing at least one radio frequency receiver device (50) that is electrically coupled to a switch (60) that is electrically coupled to a radio frequency antenna (61) makes capable the efficient wire free reception of at least one modulated radio carrier frequency. In the preferred embodiment of the present invention frequencies assigned to the international ISM bands are preferred carrier frequencies. However other frequencies are also suitable and may include frequencies outside the assigned international ISM bands. In the preferred embodiment of the present invention the wire free receiver device (50) is an integrated circuit possessing all the circuitry and functionality required to amplify, heterodyne, demodulate and convert to a digital data a received modulated radio carrier frequency and convert this signal into digital data. However other radio frequency receiver circuits and devices (50) are also suitable. Those knowledgeable in the art understand what receiver circuits and devices (50) are best suited for wire free receivers. Moreover in the preferred embodiment of the present invention demodulation of an at least one amplitude shift keyed wire free carrier frequency is employed. However other demodulation schemes are suitable for other wire free carrier modulation schemes that include but are not limited to frequency shift keying, phase shift keying, frequency modulation and quadrature amplitude modulation. The processor controller (30) being electrically coupled to the wire free receiver device (50) receives the digital data from the wire free receiver device (50). The digital data received by the processor controller (30) is processed by the processor controller (30) according to predetermined algorithms to determine the response by the processor controller (30) that may include but is not limited to the changing of the state of the at least one digital output device (33). During the time interval that the processor controller (30) is in an active state, the processor controller (30) commands the wire free receiver device (50) to receive and demodulated transmitted data. To mitigate data errors, the processor controller (30) may command the wire free receiver device (50) to receive and demodulate transmitted data more than once and in periodic or pseudo-random time intervals during time that the wire free transceiver apparatus (C) is in an active state.

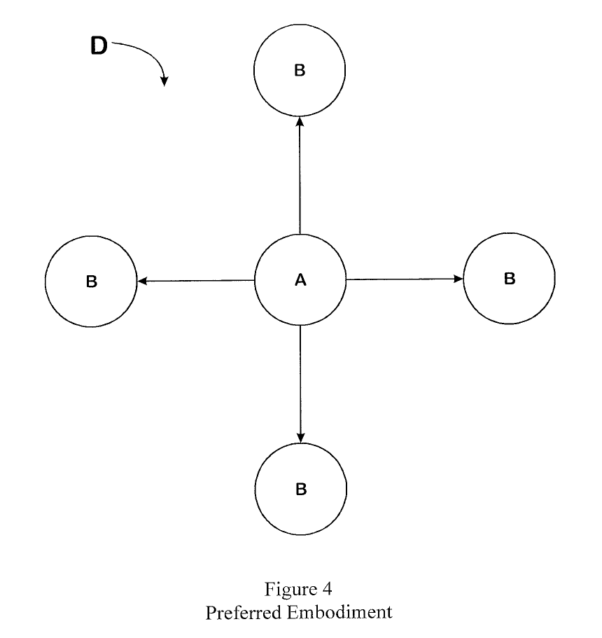

FIG. 4 generally illustrates a first embodiment of a self-powered wire free data network that includes a plurality of self-powered wire free transmitter apparatus (A) and a plurality of self powered wire free receiver apparatus (B).

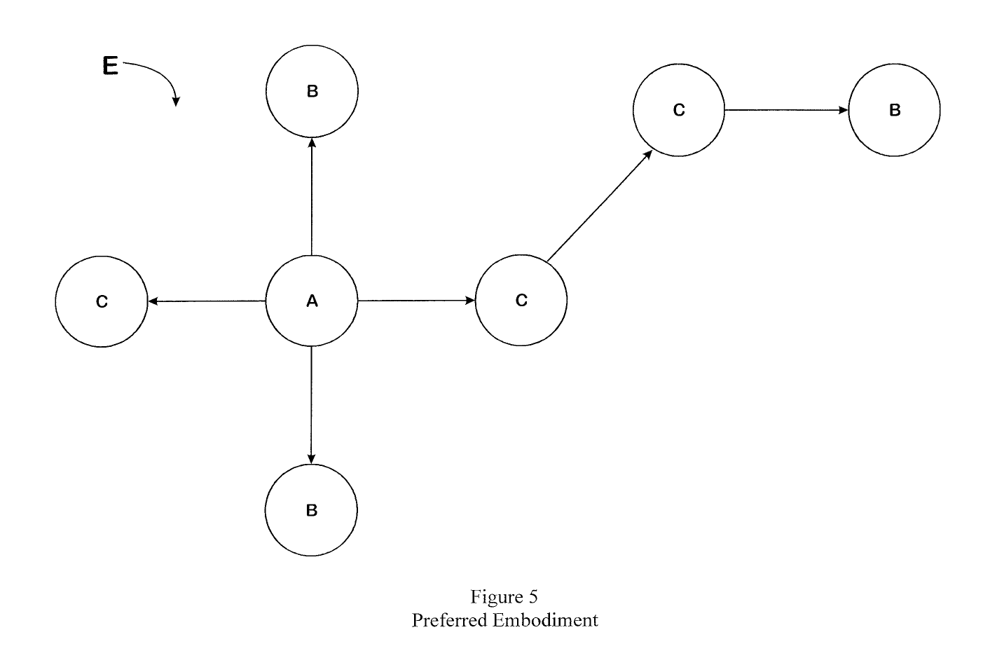

FIG. 5 generally illustrates a second embodiment of a self-powered wire free data network that includes a plurality of self-powered wire free transmitter apparatus (A) and a plurality of self powered wire free receiver apparatus (B) and a plurality of self powered wire free transceiver apparatus (C).

As implicitly stated herein, the present invention provides apparatus and methods that makes capable the construction and operation of self-powered wire free data networks. In the preferred embodiment the self-powered wire free data network includes at least one self powered wire free transmission apparatus (A), self powered wire free receiver apparatus (B) and/or self powered wire free transceiver apparatus (C).

While the present invention has been described with reference to exemplary embodiment; it is understood by those knowledgeable in the art that various alterations may be implemented and equivalents may be substituted for the elements thereof without departing from the scope of the present invention. Furthermore, numerous modifications may be implemented to adapt a particular situation or material to the teachings of the present invention without departing from the essential scope thereof. Therefore, it is intended that the present invention not be limited to the particular embodiment disclosed as the best mode contemplated for carrying out this invention; but that the invention will include all embodiments falling within the scope of the appended claims.

What is claimed is:

1. A method for self-powered wire free data networking (D), the method comprising of:
at least one self-powered wire free transmission apparatus (A) makes capable the wire free transmission of data generated by said self-powered wire free transmission apparatus (A),
at least one self-powered wire free receiver apparatus (B) makes capable the wire free reception of data transmitted by at least one wire free transmission apparatus (A).

2. A method for self-powered wire free data networking (E), the method comprising of:
at least one self-powered wire free transmission apparatus (A) makes capable the wire free transmission of data generated by said self-powered wire free transmission apparatus (A),
at least one self-powered wire free receiver apparatus (B) makes capable the wire free reception of data transmitted by at least one wire free transmission apparatus (A),
at least one self-powered wire free transceiver apparatus (C) makes capable the wire free reception of data transmitted by at least one self-powered wire free transmission apparatus (A) and whereby said received data is re-transmitted by the at least one self-powered wire free transceiver apparatus (C) makes capable a network whereby the distance over which said data is transmitted is effectively extended.

3. The self-powered wire free transmission apparatus (A), self-powered wire free receiver apparatus (B) and self-powered wire free transceiver apparatus (C) as claimed in 1 and 2 each comprising of:
at least one electrical energy generation device (10) makes capable the conversion of light, mechanical, electromechanical, electromagnetic, piezoelectric, chemical or thermal energy into electrical energy,
at least one electrical energy storage device (20) electrically coupled to the electrical energy generation device (10),
at least one voltage regulation device (22) possessing and input port electrically coupled to the electrical energy storage device (20) and possessing at least one output port that is electrically coupled to a plurality of devices within each apparatus,
at least one low power processor control device (30) comprising of at least one analog to digital conversion device (31) that possesses at least one electrically coupled input port (401) makes capable the conversion of transducer analog signals to digital data, further comprising of at least one digital input device (32) that possesses at least one electrically coupled input port (501) makes capable the conversion of logic level input signals to digital data, further comprises of at least one digital output device (33) that possesses at least one electrically coupled output port (601) makes capable the conversion of data to logic level drive signals, further comprises of at least one timer function, further comprises of at least one power managed mode, further comprises of at least one serial communication device (34) that possesses at least one electrically couple port (301) makes capable communication between the processor controller and a computer (300).

4. The self-powered wire free transmission apparatus (A), self-powered wire free receiver apparatus (B) and self-powered wire free transceiver apparatus (C) as claimed in 1 and 2 for which at least one electrical energy generation device (10) is a photovoltaic device.

5. The self-powered wire free transmission apparatus (A), self-powered wire free receiver apparatus (B) and self-powered wire free transceiver apparatus (C) as claimed in 1 and 2 for which at least one electrical energy generation device (10) is a wind powered electrical generation device.

6. The self-powered wire free transmission apparatus (A), self-powered wire free receiver apparatus (B) and self-powered wire free transceiver apparatus (C) as claimed in 1 and 2 for which at least one electrical energy generation device (10) is a piezoelectric generation device.

7. The self-powered wire free transmission apparatus (A), self-powered wire free receiver apparatus (B) and self-powered wire free transceiver apparatus (C) as claimed in 1 and 2 for which at least one electrical energy storage device (20) is a rechargeable electrochemical voltaic device.

8. The self-powered wire free transmission apparatus (A), self-powered wire free receiver apparatus (B) and self-powered wire free transceiver apparatus (C) as claimed in 1 and 2 whereby the electrical energy generated by the photovoltaic device (10) is electrically coupled to the electrical energy storage device (20) to maintain the electrical energy storage device (20) at operating energy levels.

9. The self-powered wire free transmission apparatus (A) and self-powered wire free transceiver apparatus (C) as claimed in 1 and 2 each comprises of at least one wire free transmission device (40) electrically coupled to the at least one processor control device (30) makes capable the wire free transmission of data generated by the at least one processor controller (30).

10. The wire free transmission device (40) as claimed in 7 further comprises of at least one radio frequency transmitter device.

11. The self-powered wire free data network as claimed in 1 and 2 whereby data transmitted by each self-powered wire free transmission apparatus (A) and self-powered wire free transceiver apparatus (C) within the network contains at least one identification code.

12. A method for electrical power conservation for each self-powered wire free transmission apparatus (B) and self-powered wire free transceiver apparatus (C) as claimed in 1 and 2, the method comprises of at least one timer function and at least one power managed modes of the processor control device (30) to vary active data transmission time intervals and durations.

13. The self-powered wire free receiver apparatus (B) and self-powered wire free transceiver apparatus (C) as claimed in 1 and 2 each comprises of at least one wire free receiver device (50) electrically coupled to the at least one processor control device (30) makes capable the wire free reception and processing of transmitted data.

14. The wire free receiver device (50) as claimed in 11 further comprises of at least one radio frequency receiver device.

15. A method whereby data received by at least one self-powered wire free receiver apparatus (B) and/or at least one self-powered wire free transceiver apparatus (C) as claimed in 1 and 2 from an at least one self-powered wire free transmission apparatus (A) and/or self-powered wire free transceiver apparatus (C) as claimed in 1 and 2 makes capable the response by the at least one self-powered wire free receiver apparatus (B) and/or the at least one self-powered wire free transceiver apparatus (C) of at least one digital output device (33).

16. A method for electrical power conservation for each self-powered wire free receiver apparatus (B) and self-powered wire free transceiver apparatus (C) as claimed in 1 and 2, the method comprises of at least one timer function and at least one power managed modes of the processor control device (30) to vary active data reception time intervals and durations.
